(19) United States
(12) Patent Application Publication
(10) Pub. No.: US 2015/0209227 A1
(43) Pub. Date: Jul. 30, 2015

(54) MULTI-MEDICAMENT COMPACT KIT

(71) Applicant: Astra Prime Inc, Road Town Tortola (VG)

(72) Inventor: MORDECAI BAMBERGER, JERUSALEM (IL)

(21) Appl. No.: 14/322,192

(22) Filed: Jul. 2, 2014

Related U.S. Application Data
(60) Provisional application No. 61/947,441, filed on Mar. 4, 2014.

(30) Foreign Application Priority Data
Jan. 28, 2014 (IL) 230679

(51) Int. Cl. A61J 1/03

(52) U.S. Cl. CPC A61J 1/035

(57) ABSTRACT

The present invention provides multi-medicament kits for providing a plurality of medicaments in one package, the kit including a lower backing sheet comprising at least one visually detectable marking specifically associated with a specific medicament, a plurality of solid or liquid medicaments and a blister top cover adapted to house each of said plurality of medicaments above the at least one visually detectable marking specifically associated therewith, wherein the at least one visually detectable marking is adapted to provide information about the specific medicament housed in the blister top cover there-above.

### FIELD OF THE INVENTION

The present invention relates generally to multi-medicament kits and more specifically to methods and kits for providing a variety of medicaments in one compact package.

### BACKGROUND OF THE INVENTION

There are many occasions upon which one urgently seeks a medicament. For example, if one has a sudden headache, migraine, diarrhea, travel sickness, fever or the like. Often, one is not near one's home, nor near a pharmacy. Typically, purchasable first aid kits do not comprise the required medicaments. The sudden urgency for a medicament, however, does not necessarily warrant medical treatment or prescription drugs. Most people do not keep their entire stock of over-the-counter medicines in their bags or cars. Thus, it is of frequent occurrence that people are caught “off-guard” without quick access to the required medicament.

Various publications in the field include US2008190076, which relates to an installation for filling weekly blister packs, i.e. packaging units (11), with doses of different medicaments corresponding to the weekly requirements of several patients and to be taken by the respective patient in a certain order according to the day of the week and the time of the day, according to a doctor's prescription. Said installation is provided with output stations (19) associates with the medicaments, for automatically filling all or selected compartments (12) line-by-line. A longitudinal transport device (14) is used to sequentially transport the weekly blister packs to the output stations (16) that are individually associated with the different medicaments. The medicament doses are supplied to the output stations by means of transversal transport devices (17) individually associated with the medicaments. The longitudinal transport device and the transversal transport devices are co-ordinated in terms of transport course and transport capacity, in such a way that for each transport course of the weekly blister pack (11), in the direction of the gaps of the receiving compartment arrangement, and for each transport course of the transversal transport devices, in the linear direction of the receiving compartment arrangement, the receiving compartments (12) can be filled sequentially line-by-line, during synchronised stationary phases of the blister pack and medicament transport cycles. In order to control the output stations (16) in such a way as to fill the weekly blister pack with the prescribed medicament, an electronic control unit (41) processes information about patients, said information being continuously supplied to said unit in such a way that it is synchronised with the blister pack advancing movements.

US2011011880A relates to a machine for dispensing blister packs that are used to supply tablets, comprising: a storage enclosure (1) for storing a plurality of at least two different types of tablets, including at least one platform (2) on which the tablets or pre-filled blister packs are deposited, which packs include tablet selection means; means for extracting the tablets from said at least one platform and conveying same to a blister strip to be filled; a device (4) for supplying blister pack strips (3), associated with means for transporting said blister strips (3); means for sealing the blister strips (3); and means for controlling and introducing data (5) associated with the tablet selection means, such that a blister strip can be filled with two or more different types of tablets.

There still remains an unmet need to provide convenient packages and kits for multiple medicaments.

### SUMMARY OF THE INVENTION

It is an object of some aspects of the present invention provide convenient packages and kits for multiple medicaments In some embodiments of the present invention, improved methods and apparatus are provided for providing kits for multiple medicaments.

In some embodiments of the present invention, improved methods and apparatus are provided for providing kits for multiple medicaments with portable device-readable instructions.

In some further embodiments of the present invention, improved methods and apparatus are provided for providing kits for multiple medicaments with improved labeling and portable device-readable instructions.

In some further embodiments of the present invention, improved methods and apparatus are provided for providing kits for multiple medicaments with improved labeling and both printed instructions and portable device-readable instructions.

In some further embodiments of the present invention, improved methods and apparatus are provided for providing kits for multiple medicaments with improved labeling and both printed instructions and smart-phone readable instructions.

In other embodiments of the present invention, a method and system is described for providing travel kits for housing multiple medicaments in one package.

In other embodiments of the present invention, a method and system is described for providing travel kits for housing multiple medicaments in one blister-pack package.

There is thus provided according to an embodiment of the present invention, a multi-medicament kit for providing a plurality of medicaments in one package, the kit including;
a. a lower backing sheet including at least one visually detectable marking specifically associated with a specific medicament;
b. a plurality of medicaments; and
c. a blister top cover adapted to house each of the plurality of medicaments above the at least one visually detectable marking specifically associated therewith,

wherein the at least one visually detectable marking is adapted to provide information about the specific medicament housed in the blister top cover there-above.

Additionally, according to an embodiment of the present invention, the at least one visually detectable marking includes at least one bar code.

Moreover, according to an embodiment of the present invention, the at least one visually detectable marking includes at least one two-dimensional bar code.

Furthermore, according to an embodiment of the present invention, the at least one two-dimensional bar code includes a plurality of two dimensional barcodes, each one associated with one of the plurality of medicaments.

Yet further, according to an embodiment of the present invention, each the two-dimensional bar code is adapted to provide information about the specific medicament housed in the blister top cover there-above.

Additionally, according to an embodiment of the present invention, each the two-dimensional bar code is adapted to be scanned by an optical scanner on a device to upload the information about the specific medicament onto the device.

Moreover, according to an embodiment of the present invention, the device is a smartphone.

Furthermore, according to an embodiment of the present invention, the plurality of medicaments includes at least one of;
a. at least one painkiller;
b. at least one anti-inflammatory;
c. at least one fever reducing agent;
d. at least one anti-histamine;
e. at least one laxative;
f. at least one anti-diarrhea agent; and
g. at least one antacid medicament.

Additionally, according to an embodiment of the present invention, the plurality of medicaments are all over-the-counter (OTC) medicaments.

Furthermore, according to an embodiment of the present invention, the plurality of medicaments are all at dosages suitable for an adult.

Alternatively, according to an embodiment of the present invention, the plurality of medicaments are all at dosages suitable for a child.

Moreover, according to an embodiment of the present invention, the plurality of medicaments are all at dosages suitable for a baby.

Additionally, according to an embodiment of the present invention, the plurality of medicaments include at least one oral medicament and at least one suppository.

Furthermore, according to an embodiment of the present invention, the multi-medicament kit further includes a printed set of instructions relating to each medicament in the kit.

Moreover, according to an embodiment of the present invention, the multi-medicament kit further includes images of each the medicament in the kit.

Additionally, according to an embodiment of the present invention, the multi-medicament kit, further includes a package to house the kit.

Additionally or alternatively, according to an embodiment of the present invention, the visually detectable marking includes a hologram.

Additionally or alternatively, according to an embodiment of the present invention, the visually detectable marking includes printed information.

Furthermore, according to an embodiment of the present invention, the blister top cover includes printed information in the vicinity of each of the plurality of medicaments.

Additionally, according to an embodiment of the present invention, the printed information includes the name of each of the plurality of medicaments.

Furthermore, according to an embodiment of the present invention, some of the medicaments are solid.

Additionally, according to an embodiment of the present invention, all of the medicaments are solid.

Finally, the kit comprises at least one straw for drinking a liquid medicament.

The present invention will be more fully understood from the following detailed description of the preferred embodiments thereof, taken together with the drawings.

### BRIEF DESCRIPTION OF THE DRAWINGS

The invention will now be described in connection with certain preferred embodiments with reference to the following illustrative figures so that it may be more fully understood.

With specific reference now to the figures in detail, it is stressed that the particulars shown are by way of example and for purposes of illustrative discussion of the preferred embodiments of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a simplified pictorial illustration showing an upper view of a blister pack kit for provision of multiple medicaments, in accordance with a preferred embodiment of the present invention;

FIG. 2 is a simplified pictorial illustration showing a lower view of a blister pack kit for provision of multiple medicaments, in accordance with a preferred embodiment of the present invention;

FIG. 3 is a simplified pictorial illustration showing another embodiment of a lower view of a blister pack kit for provision of multiple medicaments, in accordance with a preferred embodiment of the present invention;

FIG. 4 is a simplified pictorial illustration showing another upper view of a blister pack kit and package for provision of multiple medicaments, in accordance with a preferred embodiment of the present invention;

FIG. 5A is a simplified pictorial illustration showing an upper view of a blister pack for provision of multiple liquid medicaments, in accordance with a preferred embodiment of the present invention;

FIG. 5B is a simplified pictorial illustration showing a lower view of a blister pack for provision of multiple liquid medicaments, in accordance with a preferred embodiment of the present invention;

FIG. 6A is a simplified pictorial illustration showing a side view of a blister pack for provision of multiple liquid medicaments, in accordance with a preferred embodiment of the present invention;

FIG. 6B is a simplified pictorial illustration showing an upper view of a blister pack for provision of multiple liquid medicaments, in accordance with a preferred embodiment of the present invention;

FIG. 6C is a simplified pictorial illustration showing a lower view of a blister pack for provision of multiple liquid medicaments, in accordance with a preferred embodiment of the present invention; and

FIG. 6D is a simplified pictorial illustration showing an lower view of a blister pack with markings for provision of multiple liquid medicaments, in accordance with a preferred embodiment of the present invention.

In all the figures similar reference numerals identify similar parts.

### DETAILED DESCRIPTION OF PREFERRED EMBODIMENTS

In the detailed description, numerous specific details are set forth in order to provide a thorough understanding of the invention. However, it will be understood by those skilled in the art that these are specific embodiments and that the present invention may be practiced also in different ways that embody the characterizing features of the invention as described and claimed herein.

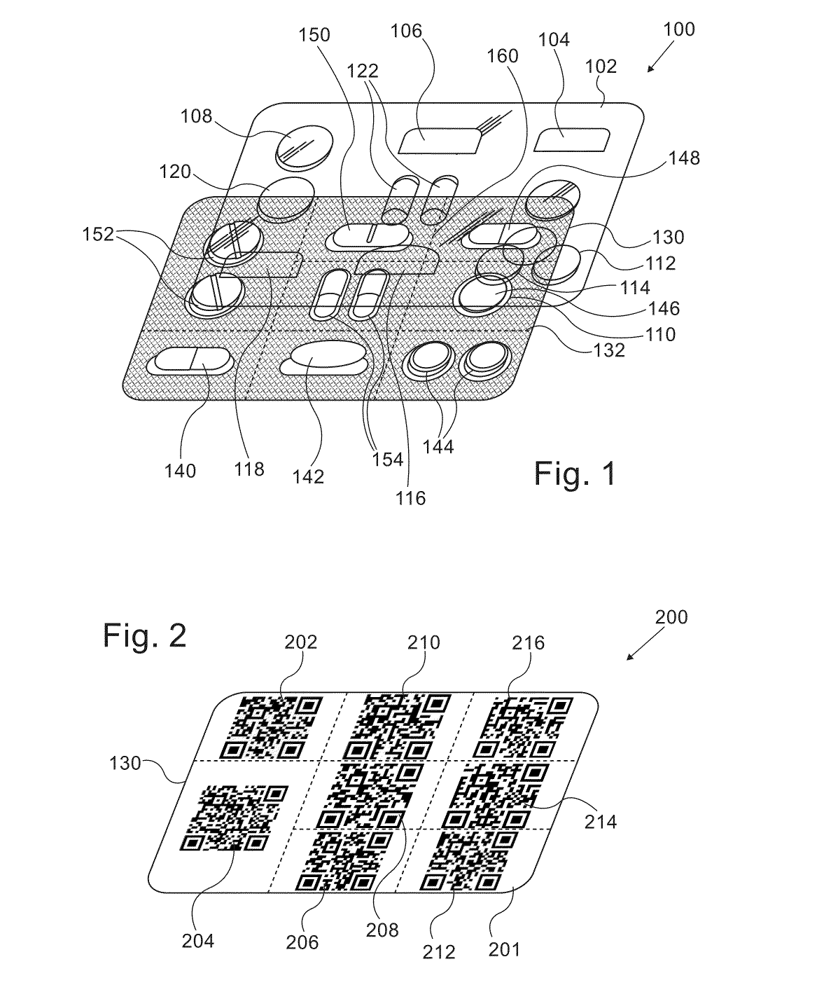

Reference is now made to FIG. 1, which is a simplified pictorial illustration showing an upper exploded view of a multi-medicament blister pack kit 100 for provision of multiple medicaments, in accordance with a preferred embodiment of the present invention.

Kit 100 comprises an upper transparent polymeric cover (blister top) 102 and a lower backing sheet 130. The blister top comprises a number of blisters 104, 106, 108, 110, 112, 114, 116, 118, 120 and 122. Each blister houses a medicament 140, 142, 144, 146, 148, 150, 152 and 154. The medicaments are of different sizes and shapes and the blisters are formed to match the contours and shapes of the medicaments.

The backing sheet may be of a single layer or multilayer, as is known in the art and comprises a number of perforations 132, to allow the removal of an individual medicament. Perforation 132 may be matched with a perforation 160 on the blister top to enable easy removal of one medicament from the kit. Typically, the backing sheet can be burst open by applying pressure thereto, as is known in the art. The backing sheet often comprises an outer aluminum foil 201 (FIG. 2).

According to some embodiments, the kit comprises a number of different medicaments.

According to some embodiments, the kit comprises a number of different over-the-counter (OTC) non-prescription medicaments.

According to one non-limiting example, the kit comprises:
a) At least one painkiller;
b) At least one anti-inflammatory;
c) At least one fever reducing agent;
d) At least one anti-histamine;
e) At least one laxative;
f) At least one anti-diarrhea agent; and
g) At least one antacid medicament.

The above example is purely exemplary and should not be deemed limiting.

According to some embodiments, the kit is a pediatric kit comprises a number of different over-the-counter (OTC) non-prescription medicaments in a dose suitable for a child.

According to one non-limiting example, the pediatric kit comprises:
a) At least one painkiller;
b) At least one anti-inflammatory;
c) At least one fever reducing agent;
d) At least one anti-histamine;
e) At least one laxative;
f) At least one anti-diarrhea agent; and
g) At least one digestive calming agent.

According to some embodiments, the kit is a baby kit comprises a number of different over-the-counter (OTC) non-prescription medicaments in a dose suitable for a baby.

According to one non-limiting example, the baby kit comprises:
a) At least one painkiller;
b) At least one anti-inflammatory;
c) At least one fever reducing agent;
d) At least one anti-histamine;
e) At least one laxative;
f) At least one anti-diarrhea agent; and
g) At least one digestive calming agent

In some cases, the medicament may be an oral tablet, capsule, lozenge or pill. In some cases, the medicament may be a suppository. The kit may comprise a number of different shapes and forms of medicaments.

Reference is now made to FIG. 2, which is a simplified pictorial illustration showing a lower view 200 of backing sheet 130 of the blister pack kit 100 (FIG. 1) for provision of multiple medicaments, in accordance with a preferred embodiment of the present invention.

Backing sheet 200 comprises a number of two-dimensional bar-codes 202, 204, 206, 208, 210, 212, 214 and 216. Each bar-code provides information relating to the medicament under which it is placed. For example, barcode 202 provides information about medicament 140, barcode 210 provides information about medicament 142, and so on. The two-dimensional barcodes can be scanned by any smart phone, such as a Nokia 808 Pureview, Samsung Galaxy S4, as is known in the art.

One example of a two dimensional barcode was initially developed, patented and owned by Toyota subsidiary Denso Wave for car parts management; who have chosen not to exercise their patent rights. Can encode Japanese Kanji and Kana characters, music, images, URLs, emails. De facto standard for Japanese cell phones.

Also used with BlackBerry Messenger to pickup contacts rather than using a PIN code. These codes are also the most frequently used type to scan with smartphones.—International Standard: ISO/IEC 18004.

The information relating to the medicament is then uploaded to the smartphone after scanning of the 2D barcode by methods known in the art. According to some embodiments, the medicament is provided without printed instructions.

According to some embodiments of the present invention, the kit has a thickness of less than one centimeter, 0.01 to 1.0 cm, 0.02 to 0.5 cm, or 1 mm to 3 mm Preferably, the kit is designed to be sufficiently thin to be conveniently placed in a wallet.

According to some further embodiments of the present invention, the kit is of a length of 1 to 20 cm, 2 to 10 cm, 3 to 8 cm, or 4 to 6 cm.

According to some further embodiments of the present invention, the kit is of a width of 1 to 15 cm, 2 to 10 cm, 3 to 8 cm, or 4 to 6 cm.

According to some further embodiments of the present invention, the kit is of dimensions that enable it can be placed in a credit card holder.

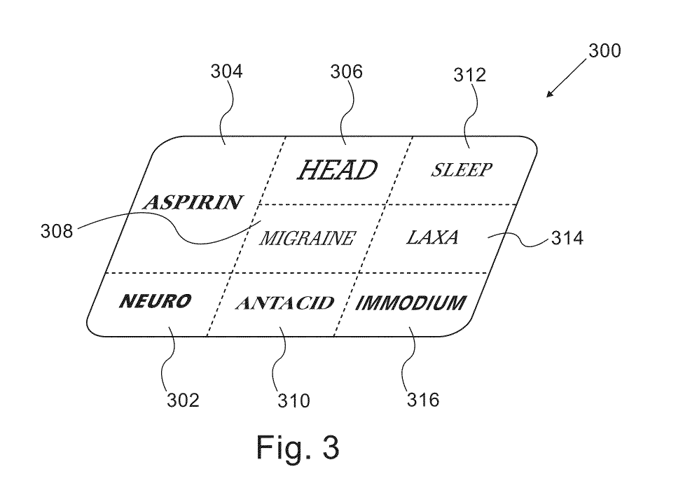

Reference is now made to FIG. 3, which is a simplified pictorial illustration showing another embodiment of a lower view 300 of a blister pack kit for provision of multiple medicaments, in accordance with a preferred embodiment of the present invention. In this embodiment, the backing sheet 130 comprises a plurality of holograms 302, 304, 306, 308, 310, 312, 314 and 316. Each hologram comprises information relating to the medicament which is placed thereupon. For example, hologram 304 may be under medicament 140, 302 under 152 and so on. The hologram may comprise a trade name of the medicament, and or its function as is illustrated in the figure.

Additionally or alternatively, the holograms may be replaced with other indicia such as stickers or printed information. In some cases, there may be at least one of a hologram and a barcode associated with the medicament and placed directly therebelow in the kit. Many combinations and permutations of these embodiments are within the scope of the present invention.

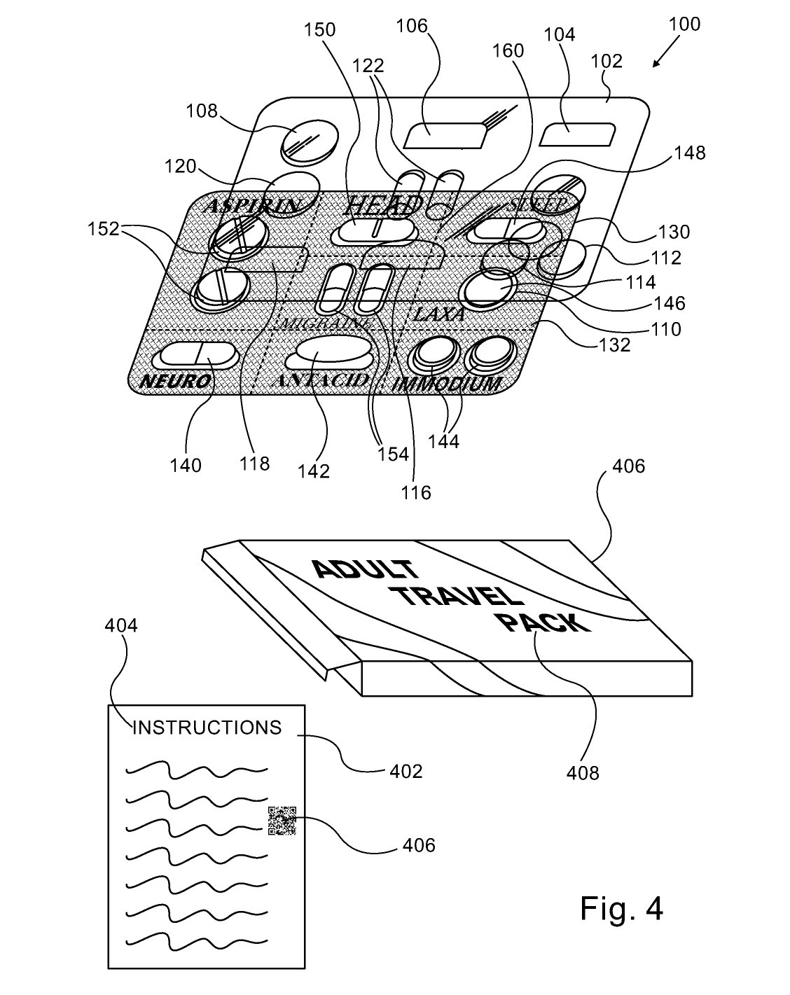

Reference is now made to FIG. 4, which is a simplified pictorial illustration showing another upper exploded view of a blister pack kit 400 and package 406 for provision of multiple medicaments, in accordance with a preferred embodiment of the present invention.

According to this embodiment, kit 100 of FIG. 1 further comprises a package 406 with a name 408 and a list of instructions 402 with the instructions printed thereupon. For example, the list may list the medicaments and show an image 406 of each of them.

In accordance with some embodiments, different kits may be provided with a different assortment of medications for different purposes. For example, a travel kit may comprise an anti-travel sick pill, in addition to the others illustrated.

A ladies kit may provide specific medicaments adapted to alleviate menstrual pains, pre-menstrual tension and the like.

According to some further embodiments of the present invention, the kit comprises at least one re-sealable compartment.

According to some further embodiments of the present invention, at least one medicament is in a liquid or semi-liquid state.

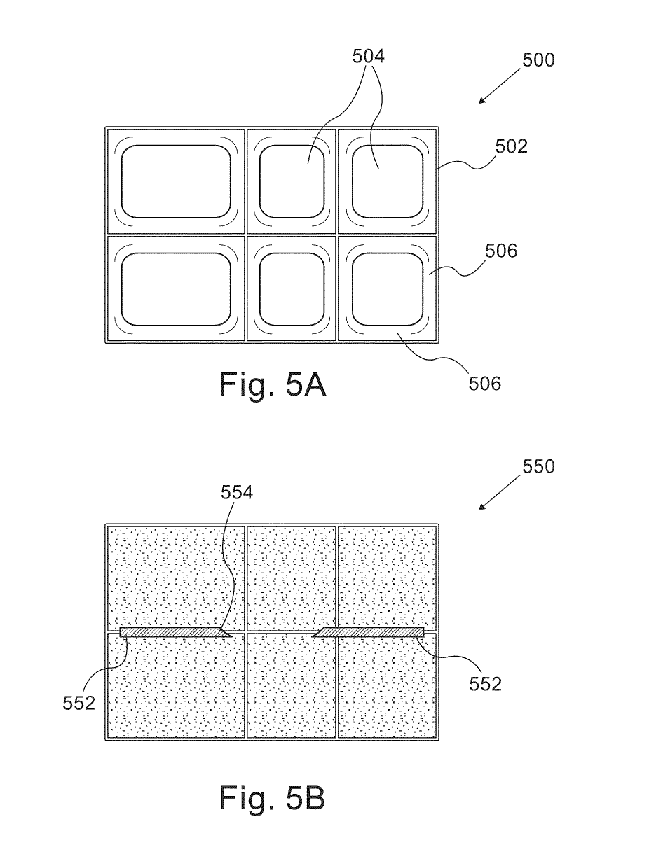

Reference is now made to FIG. 5A, which is a simplified pictorial illustration showing an upper view 500 of a blister pack 502 for provision of multiple liquid medicaments, in accordance with a preferred embodiment of the present invention.

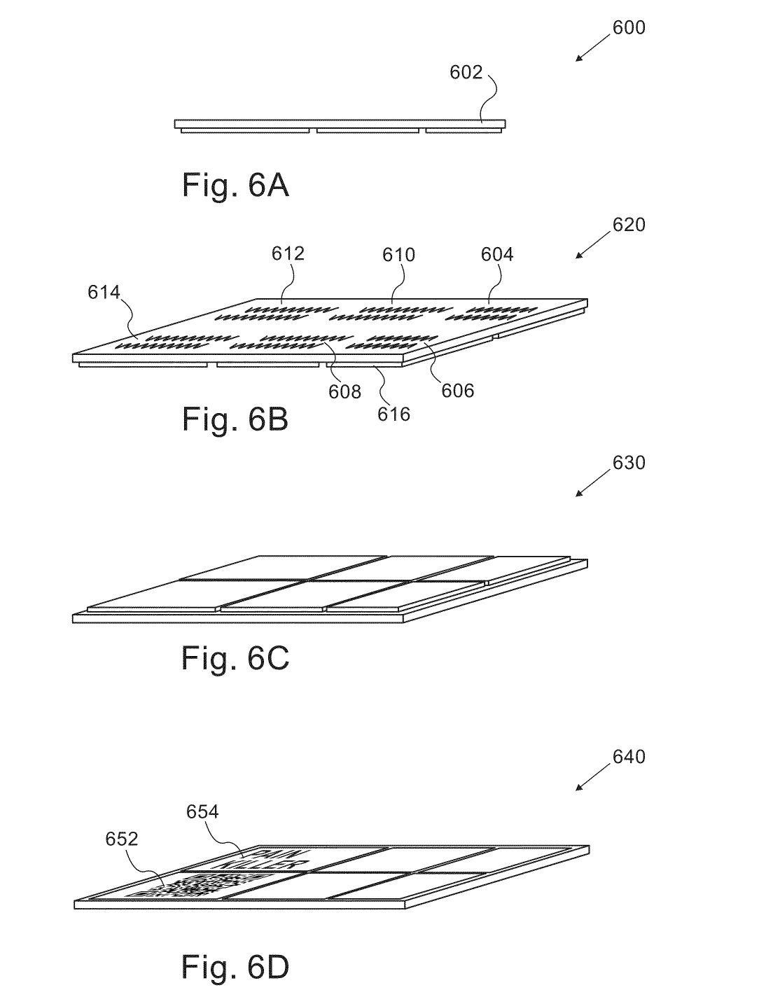

Blister pack 502 comprises a number of sealed compartments 504 for housing liquid medicaments (604, 606, 608, 610, 612 and 614 (FIG. 6)). The compartments are hollow and have raised edges. Typically the raised edges are 0.05 to 1 mm, 1 mm to 2 mm, 2 mm to 4 mm high. The edges may be straight or rounded. The simplified drawing is meant to be exemplary and not limiting.

Turning to FIG. 5B, there is seen a simplified pictorial illustration showing a lower view 550 of the blister pack for provision of multiple liquid medicaments, in accordance with a preferred embodiment of the present invention. The blister pack may conveniently be provided with one or more straws 552, each having a sharp pointed front end 554, adapted to pierce at least one compartment or pocket 504. A user can conveniently such the medicament from the compartment. The compartments may be firm or pliable.

According to one embodiment, the pack is 7-9 cm in length and 4-6 cm in breadth. Preferably, the pack is of a credit card size of 8.5 cm by 5.5 cm. The height of the pack is 0.5 to 1 mm, 1 mm to 2 mm, 2 mm to 4 mm The volume of the compartments are typically 0.1 to 5 ml, 0.5 to 1 ml, or 1-3 ml.

The liquid medicament may be in the form of a liquid, an emulsion, a suspension, a slurry, a syrup, a viscous gel or any other suitable form. The liquid medicament may, according to some embodiments, contain liposomes.

Reference is now made to FIG. 6A is a simplified pictorial illustration showing a side view 600 of a blister pack 602 for provision of multiple liquid medicaments, in accordance with a preferred embodiment of the present invention. Here, the dimensions of the pack are a credit card size of 8.5 cm length by 5.5 cm by breadth and by 2 mm height.

The blister pack comprises a variety of medicaments, such as:
a) At least one painkiller;
b) At least one anti-inflammatory;
c) At least one fever reducing agent;
d) At least one anti-histamine;
e) At least one laxative;
f) At least one anti-diarrhea agent; and
g) At least one antacid medicament.

Alternatively, there may be different types of the same type of medicament, such as different painkillers.

Turning to FIG. 6B, there is seen a simplified pictorial illustration showing an upper view 620 of blister pack 602 for provision of multiple liquid medicaments, in accordance with a preferred embodiment of the present invention. Each compartment 604 contains a different (or same) medicament 604, 606, 608, 610, 612 and 614.

FIG. 6C is a simplified pictorial illustration showing a lower view 630 of blister pack 602 for provision of multiple liquid medicaments, in accordance with a preferred embodiment of the present invention.

Additionally, FIG. 6D shows the blister pack with markings 652 (a two dimensional bar code) and 654 (a hologram) for provision of multiple liquid medicaments, in accordance with a preferred embodiment of the present invention.

All the packs and kits of the present invention can be manufactured by standard manufacturing techniques. In the case of different liquid medicaments, each medicament would be squired into a pocket/compartment and then the compartment would be sealed with at least one of a polymeric and metallic seal. For example there may be a plastic lining seal and then an aluminum foil seal.

The references cited herein teach many principles that are applicable to the present invention. Therefore the full contents of these publications are incorporated by reference herein where appropriate for teachings of additional or alternative details, features and/or technical background.

It is to be understood that the invention is not limited in its application to the details set forth in the description contained herein or illustrated in the drawings. The invention is capable of other embodiments and of being practiced and carried out in various ways. Those skilled in the art will readily appreciate that various modifications and changes can be applied to the embodiments of the invention as hereinbefore described without departing from its scope, defined in and by the appended claims.

1. A multi-medicament kit providing a plurality of medicaments in one package, the kit comprising:
a. a lower backing sheet;
b. a plurality of non-identical medicaments; and
c. a blister top cover adapted to house each of said plurality of medicaments adjacent to said lower backing sheet,
wherein at least one of said lower backing sheet and said blister top cover comprises at least one visually detectable marking, specifically associated with each of said plurality of medicaments, said at least one visually detectable marking being adapted to provide information about an associated one of said medicaments housed in said blister top cover.

2. A multi-medicament kit according to claim 1, wherein said at least one visually detectable marking comprises at least one bar code.

3. A multi-medicament kit according to claim 2, wherein said at least one visually detectable marking comprises at least one two-dimensional bar code.

4. A multi-medicament kit according to claim 3, wherein said at least one two-dimensional bar code comprises a plurality of two dimensional barcodes, each one associated with one of said plurality of medicaments.

5. A multi-medicament kit according to claim 4, wherein each said two-dimensional bar code is adapted to provide information about said specific medicament housed in said blister top cover there-above.

6. A multi-medicament kit according to claim 5, wherein each said two-dimensional bar code is adapted to be scanned by an optical scanner on a device to upload said information about said specific medicament onto said device.

7. A multi-medicament kit according to claim 6, wherein said device is a smartphone.

8. A multi-medicament kit according to claim 1, wherein said plurality of medicaments comprises at least two distinct medicaments selected from the group consisting of:
a painkiller;
b. an anti-inflammatory;
c. a fever reducing agent;
d. an anti-histamine;
e. a laxative;
f. an anti-diarrhea agent; and
g. an antacid medicament.

9. A multi-medicament kit according to claim 1, wherein said plurality of medicaments are all over-the-counter (OTC) medicaments.

10. A multi-medicament kit according to claim 1, wherein said plurality of medicaments are all at dosages suitable for an adult.

11. A multi-medicament kit according to claim 1, wherein said plurality of medicaments are all at dosages suitable for a child.

12. A multi-medicament kit according to claim 1, wherein said plurality of medicaments are all at dosages suitable for a baby.

13. A multi-medicament kit according to claim 1, wherein said plurality of medicaments comprise at least one oral medicament and at least one suppository.

14. A multi-medicament kit according to claim 1, further comprising a printed set of instructions relating to each medicament in the kit.

15. A multi-medicament kit according to claim 14, further comprising images of each said medicament in said kit.

16. A multi-medicament kit according to claim 15, further comprising a package to house said kit.

17. A multi-medicament kit according to claim 1, wherein said visually detectable marking comprises a hologram.

18. A multi-medicament kit according to claim 1, wherein said visually detectable marking comprises a printed information.

19. A multi-medicament kit according to claim 1, wherein said blister top cover comprises printed information in the vicinity of each of said plurality of medicaments.

20. A multi-medicament kit according to claim 19, wherein said printed information comprises the name of each of said plurality of medicaments.

21. A multi-medicament kit according to claim 1, wherein at least sonic of said medicaments are liquid.

22. A multi-medicament kit according to claim 1, wherein all of said medicaments are liquid.

23. A multi-medicament kit according to claim 1, further comprising at least one drinking straw.
